(19) United States
(12) Patent Application Publication
(10) Pub. No.: US 2026/0075225 A1
(43) Pub. Date: Mar. 12, 2026

(54) SYSTEM AND METHOD FOR VIRTUALIZED VIDEO ENCODING AND DECODING, ELECTRONIC DEVICE AND STORAGE MEDIUM

(71) Applicant: MOORE THREADS TECHNOLOGY CO., LTD., Beijing (CN)

(72) Inventors: Ziwei LU, Beijing (CN); Ruibo ZHU, Beijing (CN); Xu HUANG, Beijing (CN); Liang SHAO, Beijing (CN); Ce LI, Beijing (CN)

(21) Appl. No.: 19/387,869

(22) Filed: Nov. 13, 2025

Related U.S. Application Data
(63) Continuation of application No. PCT/CN2024/093651, filed on May 16, 2024.

(30) Foreign Application Priority Data
May 16, 2023 (CN) 202310552656.3

(51) Int. Cl. H04N 19/423; G06F 9/455; H04N 19/156

(52) U.S. Cl. CPC H04N 19/423; G06F 9/45558; H04N 19/156; G06F 2009/4557

(57) ABSTRACT

A system and method for virtualized video encoding and decoding, an electronic device and a non-transitory computer-readable storage medium are provided. The system includes a virtual machine manager, a virtual machine, a virtual machine register corresponding to the virtual machine, and a video encoding and decoding kernel. The virtual machine manager is configured to configure, into the virtual machine register, configuration information of a video encoding and decoding task corresponding to the virtual machine. The video encoding and decoding kernel is configured to read the configuration information from the virtual machine register, and execute the video encoding and decoding task according to the j-th video standard and on the basis of the configuration information.

### CROSS-REFERENCE TO RELATED APPLICATIONS

The present application is a continuation application of International Patent Application No. PCT/CN2024/093651, filed on May 16, 2024, which is based on and claims the priority to Chinese Patent Application No. 202310552656.3, filed on May 16, 2023. The entire contents of the above applications are incorporated herein by references.

### BACKGROUND

Virtualization is a resource management technology, which abstracts and divides computer software and hardware system resources, to allow multiple virtual machines to multiplex one set of system resources but not limited to one set of limited system resources. With the explosive growth of the requirements of the network server for video encoding and decoding in recent years, the computing power of video encoding and decoding in graphics processing unit (GPU) chips is becoming more and more important. Virtualized video technology emerges to enhance the security, reliability and scalability of encoding and decoding tasks of the system. With the virtualized video technology, multiple independent video encoding and decoding tasks are processed simultaneously on the same set of physical resources. For example, in the scenario of virtual desktop, a large number of users operate and process videos in different video standards at the same time. Therefore, there is an urgent need for a system for virtualized video encoding and decoding with efficient video encoding and decoding processing ability.

### SUMMARY

The present disclosure provides a technical solution of a system and a method for virtualized video encoding and decoding, an electronic device and a storage medium.

A first aspect of the present disclosure provides a system for virtualized video encoding and decoding, including: a virtual machine manager, a virtual machine, a virtual machine register corresponding to the virtual machine and a video encoding and decoding kernel. The virtual machine manager is configured to configure configuration information of a video encoding and decoding task corresponding to the virtual machine into the virtual machine register. The video encoding and decoding task corresponds to a j-th video standard, and j is a positive integer greater than or equal to 1. The video encoding and decoding kernel is configured to read the configuration information from the virtual machine register and execute the video encoding and decoding task according to the j-th video standard based on the configuration information.

A second aspect of the present disclosure provides a method for virtualized video encoding and decoding, including operations as follows. A virtual machine manager configures configuration information of a video encoding and decoding task corresponding to a virtual machine into a virtual machine register corresponding to the virtual machine. The video encoding and decoding task corresponds to a j-th video standard, where j is a positive integer greater than or equal to 1. A video encoding and decoding kernel reads the configuration information from the virtual machine register, and executes the video encoding and decoding task according to the j-th video standard based on the configuration information.

A third aspect of the present disclosure provides an electronic device including a processor; and a memory configured to store processor-executable instructions. The processor is configured to invoke the instructions stored in the memory to perform the method described above.

A fourth aspect of the present disclosure provides a non-transitory computer-readable storage medium having computer program instructions stored thereon, which when executed by a processor, perform the method described above.

It should be understood that the above general description and the following detailed description are exemplary and explanatory only, and do not limit the present disclosure. Other features and aspects of the present disclosure will become apparent from the following detailed description of exemplary embodiments with reference to the accompanying drawings.

### BRIEF DESCRIPTION OF THE DRAWINGS

The accompanying drawings herein are incorporated into and constitute a part of the specification, and the accompanying drawings illustrate embodiments consistent with the present disclosure, and together with the specification, are used to explain technical solutions of the present disclosure.

FIG. 1 is a schematic diagram of a system for virtualized video encoding and decoding in the related art;

FIG. 2 is a schematic diagram of virtualized video encoding and decoding in the related art;

FIG. 3 is a schematic diagram of a system for virtualized video encoding and decoding according to an embodiment of the present disclosure;

FIG. 4 is a schematic diagram of virtualized video encoding and decoding according to an embodiment of the present disclosure;

FIG. 5 is a schematic diagram of a system for virtualized video encoding and decoding according to an embodiment of the present disclosure;

FIG. 6 is a flowchart of a method for virtualized video encoding and decoding according to an embodiment of the present disclosure; and

FIG. 7 is a block diagram of an electronic device according to an embodiment of the present disclosure.

### DETAILED DESCRIPTION

Various exemplary embodiments, features, and aspects of the present disclosure will be described in detail below with reference to the accompanying drawings. Like reference numerals in the drawings denote elements having the same or similar functions. Although various aspects of embodiments are illustrated in the drawings, the drawings need not be drawn to scale unless otherwise indicated.

As used herein specifically, the term “exemplary” means “used as an example, embodiment, or illustration”. Any embodiment illustrated herein as “exemplary” does not need to be interpreted as superior or better than the other embodiments.

Herein, the term “and/or” only indicates an association relationship describing associated objects, and means that there may be three relationships. For example, A and/or B may mean three cases: i.e., independent existence of A, existence of both A and B, and independent existence of B. In addition, the term “at least one” herein means any one of the plurality or any combination of at least two of the plurality, for example, including at least one of A, B, and C, and may mean including any one element or multiple elements selected from the set consisting of A, B, and C.

In addition, numerous specific details are given in the following embodiments in order to better illustrate the present disclosure. It will be understood by those skilled in the art that the present disclosure may be implemented without certain specific details. In some implementations, the methods, means, elements, and circuits well known to those skilled in the art are not described in detail in order to highlight the main idea of the present disclosure.

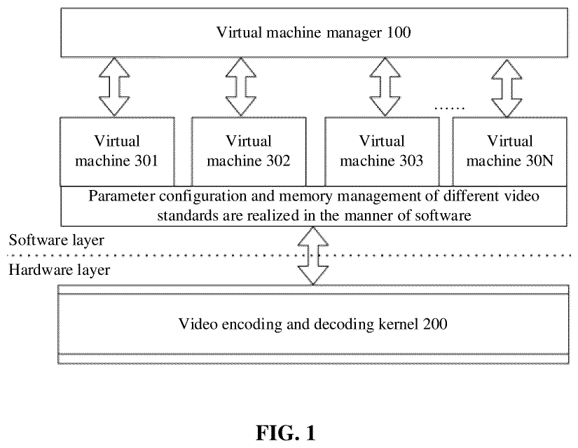

In the related art, virtualized video encoding and decoding tasks of different video standards are mainly realized by software configuration. FIG. 1 is a schematic diagram of a system for virtualized video encoding and decoding in the related art. As illustrated in FIG. 1, the flow of implementing virtualized video encoding and decoding tasks of different video standards through software configuration is described as follows.

Step 1, a video encoding and decoding task of the first video standard is started, and a virtual machine manager queries operating statuses of all virtual machines in the current system for virtualized video encoding and decoding, and the operation statuses include but not is limited to status information such as virtual machine information, whether the video encoding and decoding task is completed, and occupied storage space. The system for virtualized video encoding and decoding may include N virtual machines, and N is a positive integer greater than or equal to 2. As illustrated in FIG. 1, the software layer includes a virtual machine manager 100, a virtual machine 301, a virtual machine 302, a virtual machine 303, up to a virtual machine 30N, and the hardware layer includes a video encoding and decoding kernel 200. The virtual machine manager 100 queries the operating statuses of the virtual machine 301, the virtual machine 302, the virtual machine 303, and up to the virtual machine 30N.

Step 2, in order to avoid storage spaces of different video encoding and decoding tasks from being overlapped, the virtual machine manager allocates dedicated storage space of the current virtual machine for the current video encoding and decoding task according to the storage spaces occupied by all other virtual machines obtained from the query, and adds virtual machine information about the current virtual machine and the storage space corresponding to the current virtual machine into a management queue of the virtual machine manager for subsequent query.

Step 3, the virtual machine manager sends a series of configuration commands including query, configuration parameters, allocation of storage space, etc. to the video encoding and decoding kernel. In this process, the virtual machine information of the current virtual machine, the size of a storage space required by the current virtual machine or other information are sent to the video encoding and decoding kernel in the form of configuring a register. As illustrated in FIG. 1, parameter configuration and memory management of different video standards are realized in the software layer based on software.

Step 4, the virtual machine manager issues a control command to the video encoding and decoding kernel, and the control command includes but is not limited to a command for obtaining original video data or an encoded code stream corresponding to the video encoding and decoding task, a command for encoding and decoding the data or the code stream or other multiple commands.

Step 5, the video encoding and decoding kernel performs video encoding and decoding task operations according to the configuration and the command of the virtual machine manager, and in this process, access space and storage space of the data are limited to the dedicated storage space configured in advance by the virtual machine manager for the current virtual machine.

Step 6, after completing the video encoding and decoding task of the first video standard, the video encoding and decoding kernel interacts with the virtual machine manager in by sending an interrupt signal, to inform the virtual machine manager that the current video encoding and decoding task in the first video standard has been completed.

Step 7, after receiving the interrupt signal from the video encoding and decoding kernel, the virtual machine manager may start a video encoding and decoding task of the next video standard.

When the virtualized video encoding and decoding tasks of different video standards are implemented through software configuration, switching among different video standards will increase the response time of the system for virtualized video encoding and decoding, and increase the time uncertainty of the system for virtualized video encoding and decoding, which will affect the computing performance of the system for virtualized video encoding and decoding. The isolation processing among different video standards further increases the difficulty of accurate scheduling of the virtual machine manager in the system for virtualized video encoding and decoding. In addition, the software configuration cannot completely isolate different virtual machines in the system for virtualized video encoding and decoding, which results in that the risk of security and reliability is high. Firstly, in order to ensure the specificity of the storage space of virtual machine processes and avoid storage spaces of different virtual machine processes from being overlapped, the virtual machine manager needs to do a lot of maintenance, query and scheduling work. As more virtual machine processes are supported, the corresponding workload also increases. Secondly, because there is only one interrupt signal between the video encoding and decoding kernel and the host, the virtual machine manager performs roll polling and maintains the virtual machine process pointed to by the interrupt signal, records the reason for the completion of the virtual machine process, and queries at an appropriate time, which results in overburden of the virtual machine manager and increased management cost, and slows down a response to other interrupt signals in the system for virtualized video encoding and decoding. Thirdly, the virtual machine manager depends on the configuration process of the video encoding and decoding kernel and the calculation process of the video encoding and decoding kernel, and the video encoding and decoding kernel may perform the encoding and decoding calculation process only after the virtual machine manager completes the configuration process of encoding and decoding parameters.

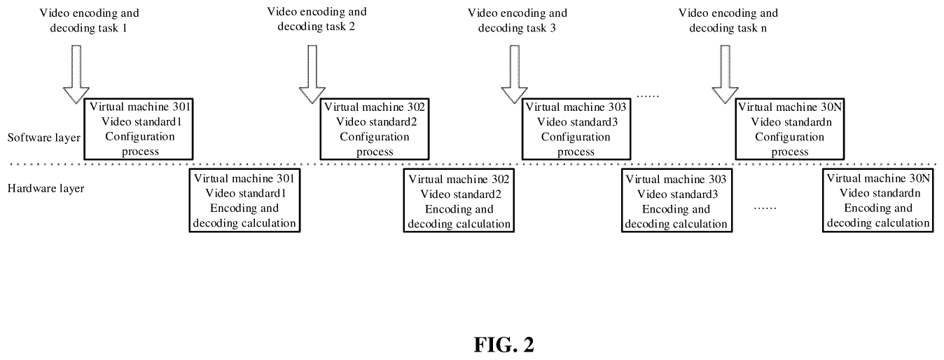

FIG. 2 is a schematic diagram of virtualized video encoding and decoding in the related art. As illustrated in FIG. 2, for the video encoding and decoding task 1 corresponding to the virtual machine 301, the virtual machine manager executes a configuration process (as illustrated in FIG. 2: virtual machine 301/video standard 1/configuration process) of the video encoding and decoding task 1 corresponding to the virtual machine 301 according to the video standard 1, and then the video encoding and decoding kernel may execute encoding and decoding calculation (as illustrated in FIG. 2: virtual machine 301/video standard 1/encoding and decoding calculation) of the video encoding and decoding task 1 corresponding to the virtual machine 301 according to the video standard 1. For the video encoding and decoding task 2 corresponding to the virtual machine 302, the virtual machine manager executes a configuration process (as illustrated in FIG. 2: virtual machine 302/video standard 2/configuration process) of the video encoding and decoding task 2 corresponding to the virtual machine 302 according to the video standard 2, and then the video encoding and decoding kernel may execute encoding and decoding calculation (as illustrated in FIG. 2: virtual machine 302/video standard 2/encoding and decoding calculation) of the video encoding and decoding task 2 corresponding to the virtual machine 302 according to the video standard 2. For the video encoding and decoding task 3 corresponding to the virtual machine 303, the virtual machine manager executes a configuration process (as illustrated in FIG. 2: virtual machine 303/video standard 3/configuration process) of the video encoding and decoding task 3 corresponding to the virtual machine 303 according to the video standard 3, and then the video encoding and decoding kernel may execute encoding and decoding calculation (as illustrated in FIG. 2: virtual machine 303/video standard 3/encoding and decoding calculation) of the video encoding and decoding task 3 corresponding to the virtual machine 303 according to the video standard 3. Until for the video encoding and decoding task n corresponding to the virtual machine 30N, the virtual machine manager executes a configuration process (as illustrated in FIG. 2: virtual machine 30N/video standard n/configuration process) of the video encoding and decoding task n corresponding to the virtual machine 30N according to the video standard n, and then the video encoding and decoding kernel may execute encoding and decoding calculation (as illustrated in FIG. 2: virtual machine 30N/video standard n/encoding and decoding calculation) of the video encoding and decoding task n corresponding to the virtual machine 30N according to the video standard n. Such serial operation mode which relies on the sequential order of software configuration and hardware encoding affects performance utilization of the video encoding and decoding kernel. In addition, when switching among different video standards, the virtual machine manager needs to re-configure the encoding and decoding parameters and calculate the size of the storage space according to different video standards, which may also increase the response time of the system for virtualized video encoding and decoding.

In order to solve the problems in implementing virtualized video encoding and decoding of different video standards through software configuration, the embodiments of the present disclosure provide a system for virtualized video encoding and decoding having the efficient video encoding and decoding processing capability. Hereinafter, a system for virtualized video encoding and decoding provided by the present disclosure will be described in detail.

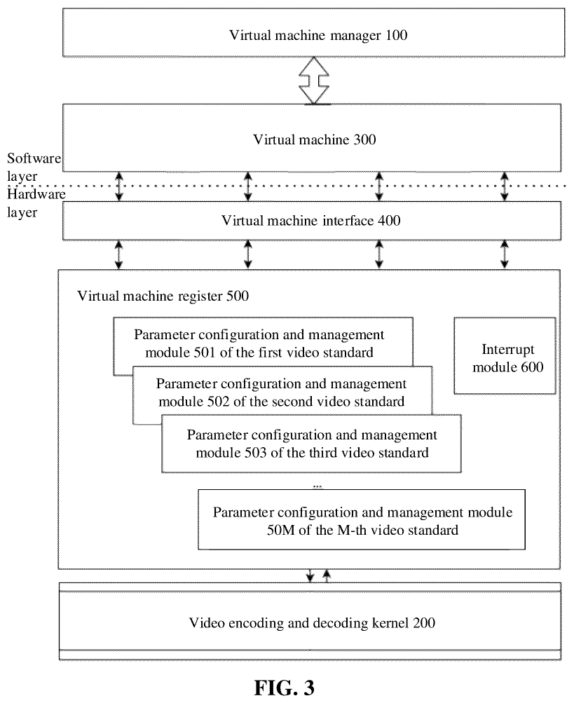

FIG. 3 is a schematic diagram of a system for virtualized video encoding and decoding according to an embodiment of the present disclosure. As illustrated in FIG. 3, the system for virtualized video encoding and decoding includes: a virtual machine manager 100, a virtual machine 300, a virtual machine register 500 corresponding to the virtual machine, and a video encoding and decoding kernel 200. The virtual machine manager 100 is configured to configure configuration information of a video encoding and decoding task corresponding to the virtual machine 300 into the virtual machine register 500. The video encoding and decoding task corresponds to a j-th video standard, and j is a positive integer greater than or equal to 1. The video encoding and decoding kernel 200 is configured to read the configuration information from the virtual machine register and execute the video encoding and decoding task according to the j-th video standard based on the configuration information.

The video encoding and decoding task corresponding to the virtual machine is the video encoding and decoding task which the virtual machine is to execute to meet the user requirement of the virtual machine. The number of video encoding and decoding tasks corresponding to one virtual machine and the form of the video standard corresponding to each video encoding and decoding task may be flexibly changed according to actual requirements, which is not limited in the present disclosure.

With the system for virtualized video encoding and decoding according to the embodiment of the present disclosure, one virtual machine is possible to flexibly execute multiple video encoding and decoding tasks corresponding to different video standards, thereby effectively improving the scalability of video virtualization, and applying the functions of video virtualization in more scenarios.

In one possible implementation, different video encoding and decoding tasks have different task numbers.

When n video encoding and decoding tasks correspond to the same virtual machine, different task numbers are used to distinguish different video encoding and decoding tasks, and n is a positive integer greater than or equal to 1. For example, one virtual machine corresponds to three video encoding and decoding tasks including video encoding and decoding task 1, video encoding and decoding task 2, and video encoding and decoding task 3.

The task numbers of different video encoding and decoding tasks may be in any form according to actual requirements, which is not limited in the present disclosure.

The video encoding and decoding task is a basic unit of a video encoding and decoding operation. The video encoding and decoding task includes two processes: a configuration process and an encoding and decoding calculation process. In the embodiment of the present disclosure, the above two processes are executed with a two-stage hardware pipelining approach, in which the first-stage hardware executes the configuration process of the video encoding and decoding task; and the second-stage video encoding and decoding kernel executes the encoding and decoding calculation process of the video encoding and decoding task. The above two processes are introduced in detail below.

In one possible implementation, the system for virtualized video encoding and decoding further includes a virtual machine interface corresponding to the virtual machine. The virtual machine manager is further configured to configure the configuration information into the virtual machine register based on the virtual machine interface.

In the system for virtualized video encoding and decoding, a virtual machine corresponds to a virtual machine interface, and the virtual machine interface corresponds to a virtual machine register. For a virtual machine, the virtual machine manager configures the configuration information of a video encoding and decoding task corresponding to the virtual machine into a virtual machine register corresponding to the virtual machine interface based on the virtual machine interface corresponding to the virtual machine, thereby realizing configuration isolation based on the form of hardware configuration.

As illustrated in FIG. 3, the virtual machine manager 100 configures the configuration information of the video encoding and decoding task corresponding to the virtual machine 300 into the corresponding virtual machine register 500 based on the virtual machine interface 400 corresponding to the virtual machine 300.

In one possible implementation, the configuration information includes: encoding and decoding parameters corresponding to the video encoding and decoding task, and a size of a storage space required for executing the video encoding and decoding task. The virtual machine register includes parameter configuration and memory management modules of M video standards, where M is a positive integer greater than or equal to 2, and the M video standards include a j-th video standard. The parameter configuration and memory management module of the j-th video standard is configured to determine encoding and decoding parameters corresponding to the video encoding and decoding task, and the size of the storage space required for executing the video encoding and decoding task.

The virtual machine register corresponding to the virtual machine in the system for virtualized video encoding and decoding includes parameter configuration and memory management modules of M video standards, so that the virtual machine may execute a video encoding and decoding task of any one of the M video standards based on the virtual machine register of hardware, thereby improving the expansibility of video virtualization and applying the functions thereof in more scenarios. The M video standards may be the general video standard in the field of video coding and decoding, and the value of M and the forms of the M video standards are not limited in the present disclosure.

As illustrated in FIG. 3, the virtual machine register 500 connected to the virtual machine 300 via the virtual machine interface 400 includes parameter configuration and management modules of M video standards: a parameter configuration and management module 501 of the first video standard, a parameter configuration and management module 502 of the second video standard, a parameter configuration and management module 503 of the third video standard, and up to a parameter configuration and management module 50M of the M-th video standard.

As illustrated in FIG. 3, the virtual machine 300 may include a virtual machine 301, a virtual machine 302, a virtual machine 303, up to a virtual machine 30N. The virtual machine interface 400 may include a virtual machine interface 401, a virtual machine interface 402, a virtual machine interface 403, up to a virtual machine interface 40N. The virtual machine register 500 may include a virtual machine register 510, a virtual machine register 520, a virtual machine register 530, and up to a virtual machine register 5N0, and the value of N may be determined according to the actual situation, which is not limited in the present disclosure.

After starting the configuration process of the i-th video encoding and decoding task (i is a positive integer greater than or equal to 1) corresponding to the virtual machine and if the i-th video encoding and decoding task corresponds to the j-th video standard, the parameter configuration and management module of the j-th video standard in the corresponding virtual machine register is invoked based on the virtual machine interface to determine the configuration information corresponding to the i-th video encoding and decoding task, which includes the encoding and decoding parameter corresponding to the i-th video encoding and decoding task and the size of the storage space required for executing the i-th video encoding and decoding task.

Further, the configuration information corresponding to the i-th video encoding and decoding task is stored in the virtual machine register, so that after starting the encoding and decoding calculation process of the i-th video encoding and decoding task, the video encoding and decoding kernel reads the configuration information from the virtual machine register, and executes encoding and decoding calculation of the i-th video encoding and decoding task according to the j-th video standard based on the configuration information.

During the encoding and decoding calculation process of the i-th video encoding and decoding task, a configuration process of the (i+1)-th video encoding and decoding task corresponding to the virtual machine may be started. If the (i+1)-th video encoding and decoding task corresponds to the (j+1)-th video standard, the parameter configuration and management module of the (j+1)-th video standard in the corresponding virtual machine register is invoked based on the virtual machine interface, to determine configuration information corresponding to the (i+1)-th video encoding and decoding task, which includes the encoding and decoding parameter corresponding to the (i+1)-th video encoding and decoding task and the size of the storage space required for executing the (i+1)-th video encoding and decoding task.

Furthermore, the configuration information corresponding to the (i+1)-th video encoding and decoding task is stored in the virtual machine register, so that after executing the encoding and decoding calculation of the i-th video encoding and decoding task, the encoding and decoding calculation process of the (i+1)-th video encoding and decoding task may be directly started since the configuration of the (i+1)-th video encoding and decoding task has been completed, the video encoding and decoding kernel reads the configuration information from the virtual machine register, and executes encoding and decoding calculation of the (i+1)-th video encoding and decoding task according to the (j+1)-th video standard based on the configuration information.

Compared with the software configuration mode of a serial operation module in which only after the configuration process and the encoding and decoding calculation process of one video encoding and decoding task are executed completely, the configuration process and the encoding and decoding calculation process of the next video encoding and decoding task may be started, the configuration process and the encoding and decoding calculation process of the video encoding and decoding task may be decoupled based on the virtual machine register of hardware in the embodiment of the present disclosure, so that when the encoding and decoding calculation of one video encoding and decoding task is executed, the configuration process of another video encoding and decoding task may be processed in parallel, thereby effectively improving the processing performance of the video encoding and decoding kernel.

For example, a virtual machine corresponds to n video encoding and decoding tasks. First, the first video encoding and decoding task is configured, and after the configuration is completed, the encoding and decoding calculation of the first video encoding and decoding task is executed, and the configuration process of another video encoding and decoding task, for example, the second video encoding and decoding task, may be processed in parallel, such that after the encoding and decoding calculation of the first video encoding and decoding task is completed, the encoding and decoding calculation of the second video encoding and decoding task may be directly performed since the configuration of the second video encoding and decoding task has been completed.

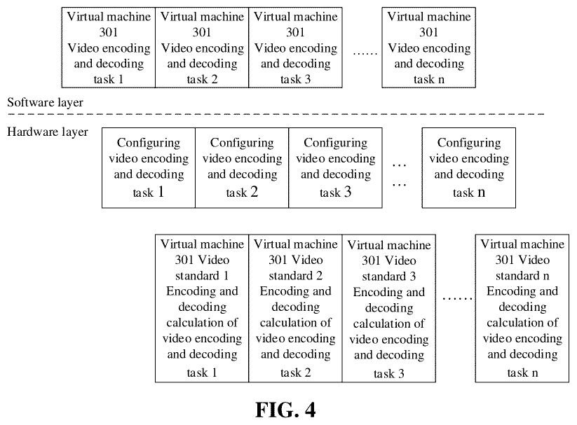

FIG. 4 is a schematic diagram of virtualized video encoding and decoding according to an embodiment of the present disclosure. As illustrated in FIG. 4, the virtual machine 301 corresponds to n video encoding and decoding tasks: virtual machine 301/video encoding and decoding task 1, virtual machine 301/video encoding and decoding task 2, virtual machine 301/video encoding and decoding task 3, up to virtual machine 301/video encoding and decoding task n. The configuration process and the encoding and decoding calculation process of the n video encoding and decoding tasks are decoupled, and the n video encoding and decoding tasks are configured sequentially. The video encoding and decoding task 1 is configured, the video encoding and decoding task 2 is configured, the video encoding and decoding task 3 is configured, until the video encoding and decoding task n is configured. The video encoding and decoding calculations are sequentially performed on the n video encoding and decoding tasks: virtual machine 301/video standard 1/encoding and decoding calculation of video encoding and decoding task 1, virtual machine 301/video standard 2/encoding and decoding calculation of video encoding and decoding task 2, virtual machine 301/video standard 3/encoding and decoding calculation of video encoding and decoding task 3, and up to virtual machine 301/video standard n/encoding and decoding calculation of video encoding and decoding task n.

In a possible implementation, the system for virtualized video encoding and decoding further includes: a storage management module and a storage unit. The storage management module is configured to allocate a corresponding target storage space for the video encoding and decoding task in the storage unit based on the size of the storage space required for executing the video encoding and decoding task.

After starting the encoding and decoding calculation process of the i-th video encoding and decoding task, the video encoding and decoding kernel reads the configuration information (including the encoding and decoding parameters corresponding to the i-th video encoding and decoding task and the size of a storage space required for executing the i-th video encoding and decoding task) of the i-th video encoding and decoding task from the virtual machine register, and the video encoding and decoding kernel sends the size of the storage space required for the i-th video encoding and decoding task to the storage management module, and the storage management module allocates the corresponding target storage space for the i-th video encoding and decoding task in the storage unit.

In one possible implementation, target storage spaces of the video encoding and decoding tasks corresponding to different virtual machines are different.

Compared with the software configuration mode in which the virtual machine manager consumes time and computing power to maintain, traverse and query the occupied state of the storage space in the current storage unit to avoid the overlap of storage spaces, hardware logic is used to allocate dedicated storage spaces for different video coding and decoding tasks of one virtual machine based on the storage management module in the embodiment of the present disclosure, thereby effectively isolate storage spaces of the video coding and decoding tasks corresponding to different virtual machines, and effectively ensuring the security of data access and storage. In addition, the query and scheduling work of the virtual machine manager is omitted, and the complexity requirement of the virtual machine manager is reduced.

In an example, when one virtual machine corresponds to n video encoding and decoding tasks, the storage unit includes dedicated storage spaces respectively allocated for the n video encoding and decoding tasks, which include: a target storage space corresponding to the first video encoding and decoding task, a target storage space corresponding to the second video encoding and decoding task, and so on, up to the target storage space corresponding to the n-th video encoding and decoding task.

In one possible implementation mode, in the process of executing the video encoding and decoding task, the video encoding and decoding kernel performs data access and storage based on the target storage space corresponding to the video encoding and decoding task.

The video encoding and decoding kernel executes encoding and decoding calculation of the i-th video encoding and decoding task based on the configuration information of the i-th video encoding and decoding task read from the virtual machine register, and in this process, the video encoding and decoding kernel performs data access and storage based on the target storage space corresponding to the i-th video encoding and decoding task in the storage unit.

In one possible implementation, the virtual machine register further includes an interrupt module which is configured to send an interrupt signal to the virtual machine manager based on the virtual machine interface after the i-th video encoding and decoding task is executed completely. The interrupt signal indicates that the i-th video encoding and decoding task is executed completely, and i is a positive integer greater than or equal to 1.

After completely executing the i-th video encoding and decoding task, the video encoding and decoding kernel sends an interrupt request to the interrupt module in the virtual machine register, and the interrupt module generates an interrupt signal in response to the interrupt request, and then sends the interrupt signal to the virtual machine register based on the virtual machine interface to inform the virtual machine manager that the i-th video encoding and decoding task is executed completely.

In the virtual machine in the system for virtualized video encoding and decoding, different video encoding and decoding tasks multiplexes the same interrupt module in the virtual machine register, thereby effectively reducing the waiting time of an interrupt process in the system. As illustrated in FIG. 3, the virtual machine register 500 includes an interrupt module 600.

In a possible implementation, the virtual machine manager is further configured to, after receiving the interrupt signal, control the video encoding and decoding kernel to execute an (i+1)-th video encoding and decoding task. The configuration information of the (i+1)-th video encoding and decoding task has been configured into the virtual machine register.

After the virtual machine manager determines that the i-th video encoding and decoding task is executed completely based on the received interrupt signal, and since the configuration information of the (i+1)-th video encoding and decoding task has been configured into the virtual machine register due to the configuration isolation mode described above, the virtual machine manager may start the encoding and decoding calculation process of the (i+1)-th video encoding and decoding task, that is, the virtual machine manager may control the video encoding and decoding kernel to execute encoding and decoding calculation of the (i+1)-th video encoding and decoding task.

In one possible implementation, in case where the system for virtualized video encoding and decoding includes multiple virtual machines, different virtual machines correspond to different virtual machine interfaces, and different virtual machines correspond to different virtual machine registers.

In one possible implementation, data access is permitted among different virtual machine video encoding and decoding tasks corresponding to one virtual machine; and data access is not permitted among the virtual video encoding and decoding tasks corresponding to different virtual machines.

The number of the multiple virtual machines included in the system for virtualized video encoding and decoding may be adjusted according to the actual requirements of the system, which is not limited in the present disclosure.

The virtual machine register in hardware can realize configuration isolation among different virtual machines and decoupling among the configuration process and the video encoding and decoding processing, thereby improving the processing performance of the video encoding and decoding kernel. The video encoding and decoding tasks of various virtual machines correspond to different dedicated storage spaces, that is, data access is permitted among the virtual video encoding and decoding tasks corresponding to different virtual machines. In this way, the video encoding and decoding tasks between various virtual machines do not affect with each other, thereby effectively improving the data security.

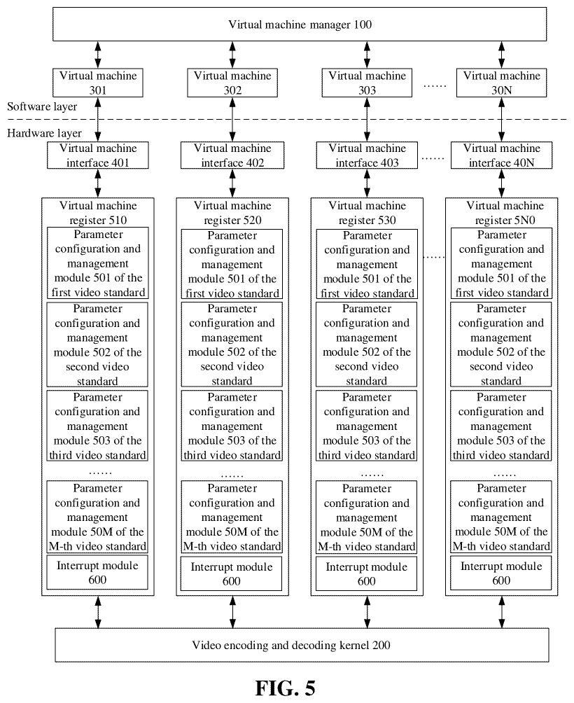

FIG. 5 is a schematic diagram of a system for virtualized video encoding and decoding according to an embodiment of the present disclosure. As illustrated in FIG. 5, the system for virtualized video encoding and decoding includes a virtual machine manager 100, a virtual machine 301, a virtual machine 302, a virtual machine 303, and up to a virtual machine 30N. The value of N may be determined according to the actual situation, which is not limited in the present disclosure. Different virtual machines correspond to different virtual machine interfaces to interface with different virtual machine registers. As illustrated in FIG. 5, the virtual machine 301 interfaces with the virtual machine register 510 based on the virtual machine interface 401, the virtual machine 302 interfaces with the virtual machine register 520 based on the virtual machine interface 402, the virtual machine 303 interfaces with the virtual machine register 530 based on the virtual machine interface 403, and up to the virtual machine 30N interfaces with the virtual machine register 5N0 based on the virtual machine interface 40N. As illustrated in FIG. 5, each virtual machine register includes parameter configuration and management modules of M video standards: a parameter configuration and management module 501 of the first video standard, a parameter configuration and management module 502 of the second video standard, a parameter configuration and management module 503 of the third video standard, and up to a parameter configuration and management module 50M of the M-th video standard, and an interrupt module 600. As illustrated in FIG. 5, the system for virtualized video encoding and decoding further includes a video encoding and decoding kernel 200.

Each of the N virtual machines included in the system for virtualized video encoding and decoding may correspond to multiple video encoding and decoding tasks. The virtual machine manager realizes configuration isolation and interrupt isolation of different virtual machines based on the virtual machine interface and the virtual machine register in hardware. Compared with software configuration, the virtual machine manager may omit complicated query scheduling work and thus reduce the time consumed by software configuration. Each virtual machine only needs to maintain configuration information and interrupt signal thereof, and there is no sensing among different virtual machines, so as to thoroughly achieve virtualization.

For example, the virtual machine manager configures the configuration information of the video encoding and decoding task corresponding to the virtual machine 301 into the virtual machine register 510 based on the virtual machine interface 401, and returns an interrupt signal corresponding to the virtual machine 301 in the virtual machine register 510 to the virtual machine manager based on the virtual machine interface 401. The virtual machine manager configures the configuration information of the video encoding and decoding task corresponding to the virtual machine 302 into the virtual machine register 520 based on the virtual machine interface 402, and returns an interrupt signal corresponding to the virtual machine 302 in the virtual machine register 520 to the virtual machine manager based on the virtual machine interface 402, and so on. The repeated process is not described here.

Regarding a process in which each virtual machine executes multiple video encoding and decoding tasks of different video standards, reference may be made to the related processes of the embodiments shown in FIG. 3 and FIG. 4 above, and will not be repeatedly described here.

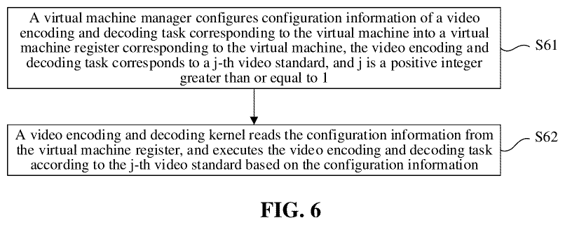

FIG. 6 is a flowchart of a method for virtualized video encoding and decoding according to an embodiment of the present disclosure. The method may be applied to the above system for virtualized video encoding and decoding, and as illustrated in FIG. 6, the method includes the following steps S61 and S62.

At step S61, a virtual machine manager configures configuration information of a video encoding and decoding task corresponding to the virtual machine into a virtual machine register corresponding to the virtual machine. The video encoding and decoding task corresponds to a j-th video standard, and j is a positive integer greater than or equal to 1.

At step S62, a video encoding and decoding kernel reads the configuration information from the virtual machine register, and executes the video encoding and decoding task according to the j-th video standard based on the configuration information.

Regarding the configuration and the encoding and decoding process of the video encoding and decoding task, reference may be made to the related processes of the embodiments shown in FIG. 3 to FIG. 5 above, and will not be repeatedly described here.

It can be understood that method embodiments described above mentioned in the present disclosure may be combined with each other to form a combined embodiment without going against the principal logic, and the present disclosure will not be repeated due to the limit of the paper. It will be understood by those skilled in the art that the specific order of execution of the steps in the method described above according to the embodiment should be determined by functions and possibly internal logic thereof.

In addition, the present disclosure further provides an electronic device, a computer-readable storage medium and a program, all of which may be used to implement any of the method for virtualized video encoding and decoding provided in the present disclosure. Regarding the corresponding technical solutions and descriptions, reference can be made to the corresponding records of the method, and the repeated description is not be provided here.

The method has specific technical correlation with the internal structure of the computer system, and can solve the technical problems including reducing the data storage amount, reducing the data transmission amount, improving the hardware processing speed or the like, and thus improve operation efficiency or the execution effect of the hardware, so as to obtain the technical effect of improving the internal performance of the computer system in accordance with the natural laws.

In some embodiments, the functions or modules contained in the device provided by the embodiment of the present disclosure may be used to perform the method described in the above method embodiment, and regarding the specific implementation of the device, reference may be made to the description of the above method embodiment, and the repeated description is not be provided here for the sake of brevity.

The embodiments of that present disclosure also provide a computer readable storage medium having computer program instructions stored thereon which, when executed by a processor, perform the method described above. The computer-readable storage medium may be a volatile computer-readable storage medium or a non-volatile computer-readable storage medium.

The embodiments of the present disclosure further provide an electronic device including: a processor; and a memory configured to store processor executable instructions. The processor is configured to invoke instructions stored in the memory to perform the method described above.

The embodiments of the present disclosure further provide a computer program product including a computer-readable code or a non-volatile computer-readable storage medium carrying the computer-readable code. When the computer-readable code is run in a processor of the electronic device, the processor in the electronic device performs the method described above.

The electronic device may be provided as a terminal, a server, or other form of device.

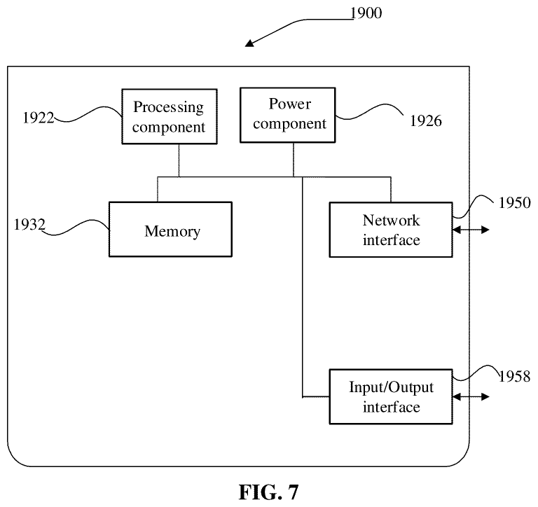

FIG. 7 illustrates a block diagram of an electronic device according to an embodiment of the present disclosure. Referring to FIG. 7, the electronic device 1900 may be provided as a server or a terminal device. Referring to FIG. 7, the electronic device 1900 includes a processing component 1922 and a memory resource represented by a memory 1932. The processing component 1922 further includes one or more processors, and the memory resource is used for storing instructions such as an application program executable by the processing component 1922. An application program stored in the memory 1932 may include one or more modules each corresponding to a set of instructions. Further, the processing component 1922 is configured to execute instructions to perform the method described above.

The electronic device 1900 may also include: a power component 1926 configured to perform power management of the electronic device 1900; a wired or wireless network interface 1950 configured to connect the electronic device 1900 to a network; and an input/output interface 1958. The electronic device 1900 may operate an operating system stored in the memory 1932, for example, a Microsoft server operating system (Windows Server™), graphical user interface-based operating system launched by Apple Inc (Mac OS X™), a multi-user and multi-process computer operating system (Unix™), a free and open source Unix-like operating system (Linux™), an open-source Unix-like operating system (FreeBSD™) or the like.

In an exemplary embodiment, a non-volatile computer-readable storage medium such as a memory 1932 including computer program instructions is further provided. The computer program instructions are executable by the processing component 1922 of the electronic device 1900 to implement the method described above.

The present disclosure may be a system, method, and/or computer program product. The computer program product may include a computer-readable storage medium on which computer-readable program instructions are loaded for causing a processor to implement various aspects of the present disclosure.

A computer-readable storage medium may be a tangible device that may hold and store instructions used by an instruction execution device. The computer-readable storage medium may be, for example, but is not limited to, an electrical storage device, a magnetic storage device, an optical storage device, an electromagnetic storage device, a semiconductor storage device, or any suitable combination thereof. More specific examples (a non-exhaustive list) of the computer-readable storage media include: a portable computer disk, a hard disk, a random access memory (RAM), a read-only memory (ROM), an erasable programmable read-only memory (EPROM or flash memory), a static random access memory (SRAM), a portable compact disk read-only memory (CD-ROM), a digital versatile disk (DVD), a memory stick, a floppy disk, a mechanical encoding device (such as a punched card or a raised structure within the groove having instructions stored thereon), and any suitable combination thereof. The computer-readable storage media used herein is not construed as the transient signal per se, such as a radio wave or other freely propagating electromagnetic wave, an electromagnetic wave (e.g., an optical pulse through a fiber optic cable) propagating through waveguide or other transmission media, or an electrical signal transmitted through an electrical wire.

The computer-readable program instructions described herein may be downloaded from a computer-readable storage medium to various computing/processing devices, or to an external computer or external storage device through a network, such as the Internet, a local area network, a wide area network, and/or a wireless network. The network may include a copper transmission cable, a fiber optic transmission, a wireless transmission, a router, a firewall, a switch, a gateway computer and/or an edge server. A network adapter card or network interface in each computing/processing device receives computer-readable program instructions from a network and forwards the computer-readable program instructions to store in a computer-readable storage medium in the respective computing/processing device.

The computer program instructions for performing the operations of the present disclosure may be assembly instructions, instruction set architecture (ISA) instructions, machine instructions, machine-related instructions, micro-codes, firmware instructions, state setting data, or source codes or object codes programmed in any combination of one or more programming languages including object-oriented programming languages such as Smalltalk, C++, and the like, and conventional procedural programming languages such as the “C” language or similar programming languages. The computer-readable program instructions may be executed entirely on the user's computer or partially on the user's computer, or executed as a standalone software package, or partially executed on the user's computer and partially executed on a remote computer, or entirely on a remote computer or server. When the remote computer is used, the remote computer may be connected to the user computer through any type of network, including a local area network (LAN) or a wide area network (WAN), or may be connected to an external computer for example, via an Internet connection by using an Internet service provider. In some embodiments, an electronic circuit, such as a programmable logic circuit, a field programmable gate array (FPGA), or a programmable logic array (PLA) can be customized by utilizing state information of computer-readable program instructions, and the electronic circuit can execute computer-readable program instructions, to implement various aspects of the present disclosure.

Various aspects of the present disclosure are described herein with reference to flowcharts and/or block diagrams of the method, the apparatus (system), and the computer program product according to the embodiments of the present disclosure. It should be understood that each block of the flowchart and/or block diagrams and combinations of blocks in the flowchart and/or block diagrams may be implemented by computer-readable program instructions.

The computer-readable program instructions may be provided to a processor of a general-purpose computer, a special-purpose computer or other programmable data processing apparatus, to produce a machine, such that the instructions, when executed by the processor of the computer or other programmable data processing apparatus, generate an apparatus for implementing the functions/operations specified in one or more blocks in the flowcharts and/or block diagrams. Such computer-readable program instructions may also be stored in a computer-readable storage medium, and the computer-readable program instructions cause the computer, the programmable data processing apparatus, and/or other devices to operate in a particular manner. In this way, the computer-readable medium storing the instructions include a manufactured produce including instructions that implement various aspects of the functions/operations specified in one or more blocks in the flowcharts and/or block diagrams.

The computer-readable program instructions may also be loaded onto a computer, other programmable data processing apparatus or other devices, and a series of operational steps to be performed on the computer, other programmable data processing apparatus or other devices to produce a computer-implemented process, such that the instructions executed on the computer, other programmable data processing apparatus or other devices implement the functions/operations specified in one or more blocks in the flowcharts and/or block diagrams.

The flowcharts and block diagrams in the accompanying drawings illustrate the architecture, the functionality, and the operation which may be implemented by systems, methods, and computer program products according to various embodiments of the present disclosure. In this regard, each block in the flowcharts or block diagrams may represent a part of a module, a program segment or an instruction, and the part of the module, the program segment or the instruction includes one or more executable instructions for implementing a logical function. In some alternative implementations, the function represented in the blocks may also occur in a different order from that noted in the drawings. For example, two consecutive blocks may actually be executed substantially in parallel, and may sometimes be executed in a reverse order, depending on the functions. It is also noted that each block in the block diagrams and/or flowchart diagrams and combinations of blocks in the block diagrams and/or flowchart diagrams may be implemented with a dedicated hardware-based system that performs the specified functions or operations, or may be implemented with a combination of dedicated hardware and computer instructions.

The computer program product may be implemented by means of hardware, software or a combination thereof. In an alternative embodiment, the computer program product is specifically embodied as a computer storage medium, and in another alternative embodiment, the computer program product is specifically embodied as a software product, such as a software development kit (SDK) or the like.

The above description for the various embodiments emphasizes differences between the various embodiments, and regarding the similarities or commonalities thereof, reference may be made to each other, and repeated description is not provided herein for the sake of brevity.

It will be understood by those skilled in the art that in the method described above of the detailed embodiment, the described order of the steps does not mean a strict order of execution and thus constitutes any limitation on the implementation process, and the order of execution of the steps should be determined by functions and possible internal logic thereof.

If the technical solution of the present disclosure involves personal information, the product applying the technical solution of the present disclosure has clearly been informed about the personal information processing rule and has obtained the autonomous personal consent before processing the personal information. If the technical solution of the present disclosure involves sensitive personal information, the product applying the technical solution of the present disclosure has obtained the separate personal consent and met the requirement of “explicit consent” at the same time before processing the sensitive personal information. For example, at a personal information collection device such as a camera, a clear and obvious sign is set to inform that it has entered a personal information collection scope, and the personal information is collected. If the person voluntarily enters the collection scope, which is regarded as that collection of personal information is allowed by the person. Alternatively, in case that obvious identification/information is used to inform the personal information processing rule on the personal information processing device, personal permission is obtained through pop-up information or by uploading personal information thereof by the person. The personal information processing rule may include a personal information processor, a personal information processing purpose, a processing method, the type of personal information to be processed, and other information.

Although various embodiments of the present disclosure have been described above, the above description is exemplary, rather than exhaustive, and is not limited to the disclosed embodiments. Many modifications and alterations are apparent to those skilled in the art without departing from the scope and spirit of the various embodiments described. The selection of terms used herein are used to best explain the principles, practical applications or improvements to techniques in the market of the various embodiments, or to enable others of ordinary skill in the art to understand the various embodiments disclosed herein.

1. A system for virtualized video encoding and decoding comprising: a virtual machine manager, a virtual machine, a virtual machine register corresponding to the virtual machine, and a video encoding and decoding kernel,
wherein the virtual machine manager is configured to configure configuration information of a video encoding and decoding task corresponding to the virtual machine into the virtual machine register, the video encoding and decoding task corresponding to a j-th video standard, and j being a positive integer greater than or equal to 1; and
the video encoding and decoding kernel is configured to read the configuration information from the virtual machine register and execute the video encoding and decoding task according to the j-th video standard based on the configuration information.

2. The system of claim 1, further comprising: a virtual machine interface corresponding to the virtual machine, and
wherein the virtual machine manager is further configured to configure the configuration information into the virtual machine register based on the virtual machine interface.

3. The system of claim 1, wherein the configuration information comprises encoding and decoding parameters corresponding to the video encoding and decoding task and a size of a storage space required for executing the video encoding and decoding task,
the virtual machine register comprises parameter configuration and memory management modules of M video standards, M being a positive integer greater than or equal to 2, and the M video standards comprising the j-th video standard; and
the parameter configuration and memory management module of the j-th video standard is configured to determine the encoding and decoding parameters corresponding to the video encoding and decoding task and the size of the storage space required for executing the video encoding and decoding task.

4. The system of claim 3, further comprising a storage management module and a storage unit,
wherein the storage management module is configured to allocate a target storage space for the video encoding and decoding task in the storage unit based on the size of the storage space required for executing the video encoding and decoding task.

5. The system of claim 4, wherein the video encoding and decoding kernel performs data access and storage based on the target storage space corresponding to the video encoding and decoding task in a process of executing the video encoding and decoding task.

6. The system of claim 2, wherein different video encoding and decoding tasks have different task numbers.

7. The system of claim 6, wherein the virtual machine register further comprises an interrupt module, and
wherein the interrupt module is configured to send an interrupt signal to the virtual machine manager based on the virtual machine interface after an i-th video encoding and decoding task is executed completely, the interrupt signal indicating that the i-th video encoding and decoding task is executed completely, and i being a positive integer greater than or equal to 1.

8. The system of claim 7, wherein the virtual machine manager is further configured to control the video encoding and decoding kernel to execute an (i+1)-th video encoding and decoding task after receiving the interrupt signal, wherein configuration information of the (i+1)-th video encoding and decoding task has been configured into the virtual machine register.

9. The system of claim 2, wherein in case that the system comprises a plurality of virtual machines, different virtual machines correspond to different virtual machine interfaces, and different virtual machines correspond to different virtual machine registers.

10. The system of claim 9, wherein data access is permitted among different virtual machine video encoding and decoding tasks corresponding to one virtual machine; and
data access is not permitted among virtual video encoding and decoding tasks corresponding to different virtual machines.

11. A method for virtualized video encoding and decoding, comprising:
configuring, by a virtual machine manager, configuration information of a video encoding and decoding task corresponding to a virtual machine into a virtual machine register corresponding to the virtual machine, the video encoding and decoding task corresponding to a j-th video standard, and j being a positive integer greater than or equal to 1; and
reading, by a video encoding and decoding kernel, the configuration information from the virtual machine register, and executing, by the video encoding and decoding kernel, the video encoding and decoding task according to the j-th video standard based on the configuration information.

12. The method of claim 11, further comprising:
configuring, by the virtual machine manager, the configuration information into the virtual machine register based on a virtual machine interface corresponding to the virtual machine.

13. The method of claim 11, wherein the configuration information comprises encoding and decoding parameters corresponding to the video encoding and decoding task and a size of a storage space required for executing the video encoding and decoding task,
the virtual machine register comprises parameter configuration and memory management modules of M video standards, M being a positive integer greater than or equal to 2, and the M video standards comprising the j-th video standard, and the method further comprises:
determining, by the parameter configuration and memory management module of the j-th video standard, the encoding and decoding parameters corresponding to the video encoding and decoding task and the size of the storage space required for executing the video encoding and decoding task.

14. The method of claim 13, further comprising:
allocating, by a storage management module, a target storage space for the video encoding and decoding task in a storage unit based on the size of the storage space required for executing the video encoding and decoding task.

15. The method of claim 14, further comprising:
performing, by the video encoding and decoding kernel, data access and storage based on the target storage space corresponding to the video encoding and decoding task in a process of executing the video encoding and decoding task.

16. The method of claim 12, wherein different video encoding and decoding tasks have different task numbers.

17. The method of claim 16, further comprising:
sending, by an interrupt module, an interrupt signal to the virtual machine manager based on the virtual machine interface after an i-th video encoding and decoding task is executed completely, the interrupt signal indicating that the i-th video encoding and decoding task is executed completely, and i being a positive integer greater than or equal to 1.

18. The method of claim 17, further comprising:
controlling, by the virtual machine manager, the video encoding and decoding kernel to execute an (i+1)-th video encoding and decoding task after receiving the interrupt signal, wherein configuration information of the (i+1)-th video encoding and decoding task has been configured into the virtual machine register.

19. An electronic device, comprising:
a processor; and
a memory having processor-executable instructions stored thereon;
wherein the processor is configured to invoke the processor-executable instructions stored in the memory to:
configuring configuration information of a video encoding and decoding task corresponding to a virtual machine into a virtual machine register corresponding to the virtual machine, the video encoding and decoding task corresponding to a j-th video standard, and j being a positive integer greater than or equal to 1; and
reading the configuration information from the virtual machine register, and executing the video encoding and decoding task according to the j-th video standard based on the configuration information.

20. A non-transitory computer-readable storage medium having computer program instructions stored thereon, wherein the computer program instructions, when executed by a processor, perform the method of claim 11.
